(19) United States
(12) Patent Application Publication
(10) Pub. No.: US 2006/0251963 A1
(43) Pub. Date: Nov. 9, 2006

(54) Non-aqueous electrolyte secondary battery

(76) Inventors: Takuya Nakashima, Osaka (JP); Masatoshi Nagayama, Osaka (JP); Yoshiyuki Muraoka, Osaka (JP)

Correspondence Address: MCDERMOTT WILL & EMERY LLP, 600 13TH STREET, N.W., WASHINGTON, DC, 20005-3096, US

(21) Appl. No.: 11/396,903

(22) Filed: Apr. 4, 2006

(30) Foreign Application Priority Data
Apr. 5, 2005 (JP) 2005-108368

(51) Int. Cl. H01M 2/16

(52) U.S. Cl. 429/144; 429/246

(57) ABSTRACT

To provide a high power non-aqueous electrolyte secondary battery with high performance and less degradation in capacity even when high power discharge is repeated while maintaining the initial output characteristic by optimizing the insulating structure between the positive and negative electrodes, in a non-aqueous electrolyte secondary battery including a positive electrode, a negative electrode, a microporous resin separator and an electrolyte, an area per theoretical capacity of the positive electrode is set to 190 to 800 cm²/Ah and a porous heat-resistant layer having a thickness of 10 to 60 μm is provided between the separator and at least one of the positive electrode and the negative electrode.

### BACKGROUND OF THE INVENTION

The present invention relates to a non-aqueous electrolyte secondary battery. More particularly, the invention relates to a high power non-aqueous electrolyte secondary battery.

Non-aqueous electrolyte secondary batteries, particularly lithium ion secondary batteries, now have a high operating voltage and a high energy density. Accordingly, the application of lithium ion secondary batteries has been accelerated. They are used not only as power sources for driving portable electronic devices including cell phones, notebook computers and video camcorders, but also as power sources for devices that require high power such as power tools and electric vehicles. Particularly for hybrid electric vehicle (HEV) application, lithium ion secondary batteries are being actively developed as an alternative high capacity power source to replace nickel-metal hydride storage batteries that are currently available. High power lithium ion secondary batteries for such application, unlike those for consumer use, are designed to instantly provide a large current by increasing an electrode area to facilitate the battery reaction.

In order to prevent short-circuited area from spreading in the case where a lithium ion secondary battery is short-circuited (e.g., internal short-circuit) due to foreign matter inadvertently incorporated into the battery during the production process or to an accident, for example, Japanese Patent No. 3371301 proposes a porous heat-resistant layer comprising an inorganic filler (solid particles) and a binder which is carried onto an electrode active material layer. The porous heat-resistant layer is filled with an inorganic filler such as alumina or silica. The inorganic filler particles are bonded by a relatively small amount of binder (see Patent Document 1, for example). The porous heat-resistant layer is unlikely to contract even at high temperatures, so that the use of the porous heat-resistant layer can prevent the battery from overheating in the event of an internal short-circuit.

[Patent Document 1] Japanese Patent No. 3371301

### BRIEF SUMMARY OF THE INVENTION

However, when a high power lithium ion secondary battery is repeatedly discharged at high power, its capacity retention rate tends to be very low. To be more specific, the temperature of microporous resin separator increases rapidly due to Joule heat generated by high power discharge. When seen microscopically, the separator melts and the micropores that contribute to ton conduction are gradually clogged, gradually reducing the area to be involved in charge/discharge.

The porous heat-resistant layer disclosed by Patent Document 1 was considered useful for solving the above problem. When the porous heat-resistant layer was used in a high power lithium ion secondary battery having a larger electrode area, however, the voltage decreased significantly during the initial stage of high power discharge.

In view of the above, the present invention has been made. An object of the present invention is to provide a high power lithium ion secondary battery having high performance and less degradation in capacity even when high power discharge is repeated while maintaining the initial output characteristic by optimizing the insulating structure between the positive and negative electrodes.

In order to address the above problem, the present invention provides a non-aqueous electrolyte secondary battery comprising a positive electrode, a negative electrode, a microporous resin separator and a non-aqueous electrolyte, wherein an area per theoretical capacity of the positive electrode is 190 to 800 cm²/Ah, and wherein a porous heat-resistant layer having a thickness of 10 to 60 μm is provided between the separator and at least one of the positive electrode and the negative electrode.

The present inventors made various studies and found that the porous heat-resistant layer described above, which excels in short-circuit resistance, has the effect of temporarily storing heat generated near an electrode. The present inventors also found that the porous heat-resistant layer has lower ion conductivity than the microporous resin separator. Presumably, this is because the resin (e.g., polyvinylidene fluoride, or PVDF), which is used as a binder during the formation of the porous heat-resistant layer together with an inorganic oxide filler, absorbs the electrolyte and thus swells, so that the ion conductivity becomes relatively low.

Accordingly, in order to prevent a rapid increase in the separator temperature while maintaining the electrolyte retention capability (ion conductivity) by the microporous resin separator, the present inventors found that, by making the porous heat-resistant layer to have an appropriate thickness so as to fully exhibit its function of storing heat, it is possible to obtain a high power non-aqueous electrolyte secondary battery having high performance, high initial output characteristic, and less degradation in capacity even when high power discharge is repeated. On the basis of the foregoing, the present invention has been accomplished.

As used herein, “area per theoretical capacity” of the positive electrode means an area (cm²/Ah) of one main surface of the positive electrode relative to the theoretical capacity of the positive electrode.

The “theoretical capacity” of the positive electrode means a capacity determined, for example, in the following procedure. A test cell is first produced by immersing, in abundant electrolyte, a positive electrode containing a predetermined amount of positive electrode active material and a Li foil counter electrode having an excessive amount of Li which are placed facing each other. The test cell is then charged and discharged using a voltage 0.1 V higher than the end-of-discharge voltage or end-of-charge voltage. For example, if a lithium ion secondary battery of interest has an operating voltage range of 3.0 to 4.2 V (end-of-discharge voltage: 3.0 V and end-of-charge voltage: 4.2 V), the test cell is cycled in the voltage range of 3,1 to 4.3 V (end-of-discharge voltage: 3.1 V and end-of-charge voltage: 4.3 V). From the discharge capacity obtained at the second cycle, capacity per unit weight of the positive electrode active material, that is, theoretical capacity (mAh/g), can be determined. In other words, the theoretical capacity of the positive electrode is a product resulting from multiplication of the weight of active material contained in the positive electrode with the theoretical capacity of the positive electrode active material per unit weight.

According to the present invention, it is possible to provide a high power non-aqueous electrolyte secondary battery having high performance and less degradation in capacity while maintaining the initial output characteristic even when the battery is used in an HEV that requires the repetition of high power discharge.

### BRIEF DESCRIPTION OF THE SEVERAL VIEWS OF THE DRAWING

FIG. 1 is an enlarged schematic cross section of a relevant part of a non-aqueous electrolyte secondary battery according to one embodiment of the present invention.

### DETAILED DESCRIPTION OF THE INVENTION

Referring to the accompanying drawing, an embodiment of the present invention will be described below in detail. However, it should be understood that the present invention is not limited thereto.

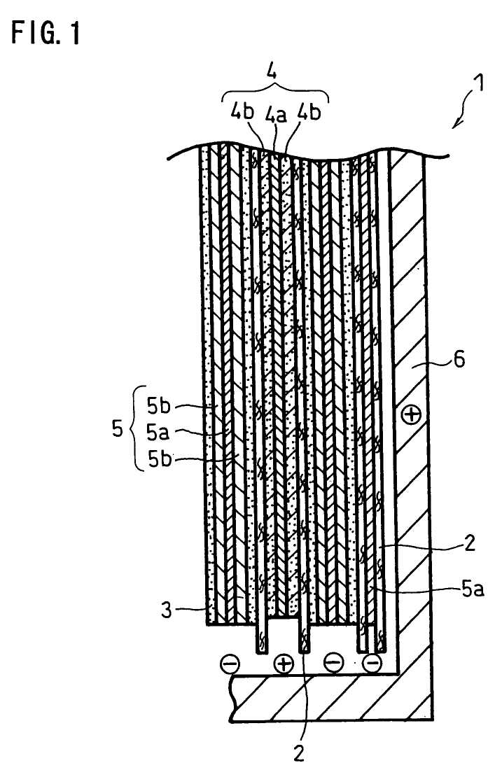

FIG. 1 is an enlarged schematic cross section of a relevant part of the electrode group contained in a non-aqueous electrolyte secondary battery according to one embodiment of the present invention. As shown in FIG. 1, an electrode group 1 comprises a separator 2, a porous heat-resistant layer 3, a positive electrode 4 and a negative electrode 5. The positive electrode 4, the separator 2, the porous heat-resistant layer 3 and the negative electrode 5 are arranged in this order to form a laminate and the laminate is spirally wound to form the electrode group 1. In other words, in the electrode group 1, the porous heat-resistant layer 3 is placed between the separator 2 and the negative electrode 5. The electrode group 1 is inserted into a battery case 6, whereby a non-aqueous electrolyte secondary battery of the present invention is obtained.

In this embodiment, the porous heat-resistant layer 3, i.e., the main component of the present invention, is formed only on a surface of the negative electrode 5. However, the porous heat-resistant layer 3 may be formed only on a surface of the positive electrode 4, or on surfaces of both the positive electrode 4 and the negative electrode 5. From the viewpoint of ensuring avoidance of internal short-circuit, it is preferred to form the porous heat-resistant layer 3 on a surface of the negative electrode 5 that often has a larger area than the positive electrode 4.

The porous heat-resistant layer 3 may be formed on a surface of the negative electrode 5, or on a surface of the separator 2. In the case of forming the porous heat-resistant layer 3 on the separator 2, great care should be taken during the formation of the porous heat-resistant layer 3 because the separator 2 can contract at high temperatures. In order to be free from such concern, the porous heat-resistant layer 3 is preferably formed on a surface of the negative electrode 5.

The shape of the porous heat-resistant layer 3 is not specifically limited. It can be, for example, an independent sheet. Since the porous heat-resistant layer 3 formed into a sheet is not sufficient in mechanical strength, care needs to be taken.

Preferably, the porous heat-resistant layer 3 comprises an insulating filler and a binder. The insulating filler for use in the porous heat-resistant layer 3 can be highly heat-resistant resin fibers or highly heat-resistant resin beads. Preferred is an inorganic oxide. Since inorganic oxides are rigid, the space between the positive and negative electrodes can be maintained within an appropriate range even if the electrodes expand due to charge/discharge. Among inorganic oxides, particularly preferred are alumina, silica, magnesia, titania and zirconia because they have high specific heat, high heat conductivity and high impact resistance, and they are electrochemically stable under lithium secondary battery operating conditions. They may be used singly or in any combination of two or more.

As the binder for binding the insulating filler, in addition to PVDF mentioned earlier, the following can be used: polytetrafluoroethylene (PTFE) and modified acrylonitrile rubber particle (e.g., BM-500B (trade name) available from Zeon Corporation, Japan). When PTFE or BM-500B is used, it is preferably used together with a thickener such as carboxymethyl cellulose (CMC), polyethylene oxide (PEO) or modified acrylonitrile rubber (BM-720H (trade name) available from Zeon Corporation, Japan). Because these resins have a high affinity for non-aqueous electrolyte, they absorb the electrolyte and swell, although the amount may vary. In addition to these resins, a heat-resistant resin such as aramid resin or polyamide-imide resin may be added for the purpose of further improving the heat resistance.

The porous heat-resistant layer 3 can be formed by applying a paste material containing an insulating filler and a small amount of binder onto a surface of the negative electrode 5 or the separator 2 using a doctor blade or die coater, for example, followed by drying. The paste material can be prepared by mixing an insulating filler, a binder and a liquid component using a double arm kneader or the like.

The thickness of the porous heat-resistant layer 3 should be set within 10 to 60 μm. When the porous heat-resistant layer 3 has a thickness of not less than 10 μm, the effect of storing heat offered by the porous heat-resistant layer 3 can be certainly obtained. When the porous heat-resistant layer 3 has a thickness of not greater than 60 μm, although the ion conductivity of the porous heat-resistant layer 3 between the positive electrode 4 and the negative electrode 5 becomes relatively low, satisfactory initial output characteristic can be certainly obtained.

The porosity of the porous heat-resistant layer 3 can be appropriately changed as long as the effect of the present invention is not impaired. From the viewpoint of maintaining sufficient mechanical strength as well as improving resistance to dropping, a preferred porosity is 40 to 80%, more preferably 45 to 55%. Because the porous heat-resistant layer 3 has lower surface smoothness than the positive electrode 4, the negative electrode 5 and the separator 2, it is possible to prevent the negative electrode 5 and the separator 2 from excessively sliding or from being displaced from each other.

The porosity of the porous heat-resistant layer 3 can be controlled by changing the median size of the insulating filler, the amount of the binder, or the conditions for drying the paste, for example. For example, a relatively high porosity can be obtained by increasing the drying temperature or the volume of hot air. The porosity can be determined by calculation using the thickness of the porous heat-resistant layer 3, the amount of the insulating filler, the amount of the binder, the absolute specific gravity of the Insulating filler, the absolute specific gravity of the binder, etc. The thickness of the porous heat-resistant layer 3 can be determined as the average of the porous heat-resistant layer thicknesses obtained from several SEM images taken at several different points in a cross section of an electrode plate. The porosity may be determined by a mercury porosirmeter.

The area of the positive electrode 4 which is the capacity-limiting electrode should be 190 to 800 cm²/Ah per theoretical capacity. If the area of the positive electrode 4 Is less than 190 cm²/Ah per theoretical capacity (i.e., the same as or lower than that of a conventional lithium ion secondary battery for consumer use), the electrode area will be small. If such positive electrode is used together with the porous heat-resistant layer 3 which is thick, the output characteristic of the resulting battery may be low.

Conversely, if the area of the positive electrode 4 exceeds 800 cm²/Ah per theoretical capacity, the thickness of the positive electrode active material layer has to be reduced. For example, the thickness of the positive electrode active material layer formed on one surface of the current collector has to be reduced to approximately 20 μm. In this case, considering that the positive electrode active material typically has a particle size (median size) of approximately 10 μm, it is difficult to form a uniformly thick positive electrode active material layer, which means it is difficult to achieve stable production.

The negative electrode 5 having an area larger than that of the positive electrode 4 should completely cover the positive electrode 4 which is the capacity-limiting electrode.

The positive electrode 4 in the present invention comprises a current collector 4a and a positive electrode active material layer 4b formed on each surface of the current collector 4a. The positive electrode active material layer 4b comprises at least a positive electrode active material, a binder and a conductive material.

As the positive electrode active material, a transition metal composite oxide such as lithium cobalt oxide can be used. The binder is not specifically limited, and PTFE or BM-500B can be used other than PVDF. When PTFE or BM-500B is used, it is preferably used together with a thickener such as CMC, PEO or BM-720H.

Examples of the conductive material include acetylene black (AB), ketjen black and various graphites. They may be used singly or in any combination of two or more.

The negative electrode 5 in the present invention comprises a current collector 5a and a negative electrode active material layer 5b formed on each surface of the current collector 5a. The negative electrode active material layer 5b comprises at least a negative electrode active material and a binder.

Examples of the negative electrode active material include various natural graphites, various artificial graphites, silicon-containing composite materials and various alloy materials. As the binder, an rubber-like polymer containing a styrene unit or butadiene unit can be used. Examples include, but not limited to, styrene-butadiene copolymer (SBR) and modified forms of SBR containing acrylic acid.

For the preparation of a negative electrode material mixture paste for forming the negative electrode 5, a thickener comprising a water-soluble polymer is used. The water-soluble polymer is preferably cellulose resin, and more preferably, CMC. The amounts of the binder and the thickener are preferably 0.1 to 5 parts by weight and 0.1 to 5 parts by weight, respectively, relative to 100 parts by weight of the negative electrode active material.

The separator 2 in the present invention is preferably a microporous film made of a resin having a melting point of not greater than 200° C. Particularly preferred are polyethylene, polypropylene, a mixture of polyethylene and polypropylene and a copolymer of ethylene and propylene. Thereby, in the event where the battery is externally short-circuited, the separator 2 melts, causing an increase in battery resistance and a decrease in short-circuit current. Consequently, the increase of the battery temperature due to the battery dissipate heat can be prevented. The thickness of the separator 2 is preferably 10 to 40 μm from the viewpoint of ensuring the ion conductivity and maintaining the energy density.

The non-aqueous electrolyte in the present invention is preferably prepared by dissolving a lithium salt (e.g. LiPF₆ or LiBF₄) as a solute in a non-aqueous solvent. Examples of the non-aqueous solvent include, but not limited to, ethylene carbonate (EC), propylene carbonate (PC), dimethyl carbonate (DMC), diethyl carbonate (DEC) and methyl ethyl carbonate (MEC). The non-aqueous solvent may be used singly, preferably, a combination of two or more.

In order to form a sufficient film on the surface of the positive electrode active material layer and/or the negative electrode active material layer so as to ensure stability in the event of overcharge, vinylene carbonate (VC), cyclohexylbenzene (CHB), a derivative of VC or a derivative of CHB can be added to the non-aqueous electrolyte.

The positive electrode 4 and the negative electrode 5 that satisfy the foregoing conditions are spirally wound with the separator 2 therebetween, whereby the electrode group 1 having a substantially circle cross section or a substantially rectangular cross section is formed. The electrode group 1 is inserted into the battery case 6 in the shape of a cylinder or prism. The non-aqueous electrolyte is then injected thereinto, and the opening of the battery case is sealed. In this manner, a non-aqueous electrolyte secondary battery of the present invention can be produced.

By connecting a plurality of the non-aqueous electrolyte secondary batteries of the present invention in series and/or in parallel, a power source device can be produced. The power source device of the present invention has high output characteristic and less degradation in capacity even when high power discharge is repeated because it comprises the non-aqueous electrolyte secondary batteries of the present invention.

It should be understood that the non-aqueous electrolyte secondary battery of the present invention Is not limited to the above embodiment, and various design modifications may be made. For example, although in the embodiment given above, the active material layer is formed on each surface of the positive electrode and the negative electrode, the active material layer may be formed only on one surface. Also, the porous heat-resistant layer is formed on each surface of the negative electrode in the above embodiment, but the porous heat-resistant layer may be formed only on one surface of the negative electrode. The porous heat-resistant layer may be formed on a surface (both surfaces or one surface) of the positive electrode.

The present invention will be described in detail below. Although the examples given below use a cylindrical battery with spirally wound design, it should be understood that the present invention is not limited to the cylindrical battery with spirally wound design. The present invention is also applicable to a prismatic battery with spirally wound design or laminate design.

### EXAMPLE 1

In this example, an electrode group having a structure shown in FIG. 1 was first produced.

A paste for forming positive electrode active material layer was prepared by mixing 30 kg of lithium cobaltate, 10 kg of PVDF #1320 (a N-methylpyrrolidone (NMP) solution with a solid content of 12 parts by weight), 900 g of acetylene black and an appropriate amount of NMP with a double arm kneader. The obtained paste for forming positive electrode active material layer was applied onto both surfaces of a 15 μm thick aluminum foil current collector, which was then dried and rolled to have a total thickness of 108 μm. Then, the resultant was cut into a size of 56 mm in width and 600 mm in length (each surface having an area of 336 cm²). Thereby, a positive electrode 4 was produced.

Meanwhile, a paste for forming negative electrode active material layer was prepared by mixing 20 kg of artificial graphite, 750 g of BM-400B (trade name) available from Zeon Corporation, Japan (a modified form of SBR containing acrylic acid with a solid content of 40 parts by weight), 300 g of CMC and an appropriate amount of water with a double arm kneader. The obtained paste for forming negative electrode active material layer was applied onto both surfaces of a 10 μm thick copper foil current collector, which was dried and rolled to have a total thickness of 119 μm. Thereby, an elongated negative electrode was produced.

Subsequently, a paste for forming porous heat-resistant layer was prepared by mixing 950 g of alumina powder having a tap density of 1.2 g/ml. 625 g of BM-720H with a solid content of 8 parts by weight and an appropriate amount of NMP with a double arm kneader. The obtained paste for forming porous heat-resistant layer was applied onto both surfaces of the elongated negative electrode by a die coater such that each surface had a thickness of 10 μm (dried), which was then dried. The resultant was then Cut into a size of 58 mm in width and 640 mm in length. Thereby, a negative electrode 5 was produced.

The positive electrode 4 and the negative electrode 5 produced above were spirally wound with a microporous polyethylene separator 2 (9420G (trade name) available from Asahi Kasei Corporation) therebetween. Thereby, a cylindrical electrode group 1 was produced. In the cylindrical electrode group 1, a portion of the aluminum foil where the paste for forming positive electrode active material layer have not been applied was exposed at the opening of the electrode group 1, and a portion of the copper foil where the paste for forming negative electrode active material layer have not been applied was exposed at the bottom of the electrode group 1.

To the exposed portion of the aluminum foil of the positive electrode 4 was welded an aluminum current collector having a thickness of 0.3 mm. To the exposed portion of the copper foil of the negative electrode 5 was welded an iron current collector having a thickness of 0.3 mm. The electrode group 1 was then inserted into a cylindrical battery case 6 having a diameter of 18 mm and a height of 68 mm. Finally, a non-aqueous electrolyte in an amount of 5.5 g prepared by dissolving 1.0 M LiPF₆ In a solvent mixture of EC and EMC at a weight ratio of 1:3 was injected into the battery case 6, and the opening of the battery case 6 was sealed.

Thereby, a cylindrical lithium ion secondary battery having a theoretical capacity of 850 mAh and a positive electrode area per theoretical capacity of 395 cm²/Ah was produced.

### EXAMPLES 2 TO 4

A cylindrical lithium ion secondary battery was produced in the same manner as in EXAMPLE 1 except that the thickness of the porous heat-resistant layer 3 was changed to 20 μm (EXAMPLE 2).

A cylindrical lithium ion secondary battery was produced in the same manner as in EXAMPLE 1 except that the thickness of the porous heat-resistant layer 3 was changed to 40 μm (EXAMPLE 3).

A cylindrical lithium ion secondary battery was produced in the same manner as in EXAMPLE 1 except that the thickness of the porous heat-resistant layer 3 was changed to 60 μm (EXAMPLE 4).

### EXAMPLE 5

A cylindrical lithium ion secondary battery was produced in the same manner as in EXAMPLE 2 except that the total thickness and the length of the positive electrode 4 were changed to 200 μm and 300 mm, respectively (area: 168 cm²), that the total thickness and the length of the negative electrode 5 were changed to 227 μm and 387 mm, respectively, and that a cylindrical battery case having a diameter of 17.5 mm was used. The produced battery had a positive electrode area per theoretical capacity of 198 cm²/Ah.

### EXAMPLE 6

A cylindrical lithium ion secondary battery was produced in the some manner as in EXAMPLE 2 except that the total thickness and the length of the positive electrode 4 were changed to 61 μm and 1200 mm, respectively (area: 672 cm²), that the total thickness and the length of the negative electrode 5 were changed to 64 μm and 1240 mm, respectively, and that a cylindrical battery case having a diameter of 20 mm was used. The produced battery had a positive electrode area per theoretical capacity of 791 cm²/Ah.

### EXAMPLE 7

A cylindrical lithium ion secondary battery was produced In the same manner as in EXAMPLE 1 except that the porous heat-resistant layer 3 having a thickness of 10 μm was not formed on both surfaces of the negative electrode 5, but formed on one surface of the positive electrode 4.

A cylindrical lithium ion secondary battery was produced in the same manner as In EXAMPLE 1 except that the porous heat-resistant layer 3 having a thickness of 10 μm was formed on one surface of the negative electrode 5 and on one surface of the positive electrode 4.

### EXAMPLES 9 AND 10

A first assembled battery was produced by connecting ten cylindrical lithium ion secondary batteries of EXAMPLE 1 in series (EXAMPLE 9).

A second assembled battery was produced by connecting ten first integrated batteries of EXAMPLE 9 in parallel (EXAMPLE 10).

### COMPARATIVE EXAMPLE 1

A cylindrical lithium ion secondary battery was produced in the same manner as In EXAMPLE 1 except that the porous heat-resistant layer 3 was not formed.

### COMPARATIVE EXAMPLES 2 AND 3

Cylindrical lithium ion secondary batteries were produced in the same manner as in EXAMPLE 1 except that the thickness of the porous heat-resistant layer 3 was changed to 7 μm or 80 μm.

### COMPARATIVE EXAMPLE 4

A cylindrical lithium ion secondary battery was produced in the same manner as In EXAMPLE 1 except that the microporous polypropylene separator 2 was not used, and that the thickness of the porous heat-resistant layer 3 was changed to 30 μm.

### COMPARATIVE EXAMPLE 5

A cylindrical lithium ion secondary battery was produced in the same manner as in EXAMPLE 2 except that the total thickness and the length of the positive electrode 4 were changed to 370 μm and 160 mm, respectively (area: 90 cm²). that the total thickness and the length of the negative electrode 5 were changed to 427 μm and 200 mm, respectively, and that a cylindrical battery case having a diameter of 17 mm was used. The produced battery had a positive electrode area per theoretical capacity of 106 cm²/Ah.

[Evaluation]

The batteries and the integrated batteries produced above were subjected to the following evaluation tests. The results are shown in Table 1.

(1) Initial Output Characteristic

Each battery was charged at a current of 1 A until the battery voltage reached 4.2 V. Then, low rate discharge was performed at a current of 0.5 A until the battery voltage reached 2.5 V. Subsequently, the battery was charged under the same condition as above, and then high rate discharge was performed at a current of 10 A until the battery voltage reached 2.5 V. Then, the rate of the high rate discharge capacity to the low rate discharge capacity was determined in percentage.

The assembled battery of EXAMPLE 9 was charged at a current of 1 A until the battery voltage reached 42 V. Then, low rate discharge was performed at a current of 0.5 A until the battery voltage reached 25 V. Subsequently, the assembled battery was charged under the same condition as above, and then high rate discharge was performed at a current of 10 A until the battery voltage reached 25 V. Likewise, the assembled battery of EXAMPLE 10 was charged at a current of 10 A until the battery voltage reached 42 V. Then, low rate discharge was performed at a current of 5 A until the battery voltage reached 25 V. Subsequently, the assembled battery was charged under the same condition as above, and then high rate discharge was performed at a current of 100 A until the battery voltage reached 25 V.

(2) High Power Discharge Cycle

Each of the batteries and assembled batteries having been subjected to the initial output characteristic test was cycled (charged and discharged) 300 times under the same condition as used in the high rate discharge. Then, the rate of the high rate discharge capacity after 300 cycles to the initial high rate discharge capacity was determined in percentage.

TABLE 1

| | Area per | | | | | |
|---|---|---|---|---|---|---|
| | theoretical | | | | | |
| | capacity of | Porous heat-resistant layer | | | | High power |
| | positive electrode | | Thickness | Microporous | Initial output | discharge cycle |
| | (cm²/Ah) | Position | (μm) | separator | (%) | (%) |
| Ex. 1 | 395 | Negative electrode | 10 | Yes | 98 | 88 |
| Ex. 2 | 395 | Negative electrode | 20 | Yes | 97 | 92 |
| Ex. 3 | 395 | Negative electrode | 40 | Yes | 95 | 95 |
| Ex. 4 | 395 | Negative electrode | 60 | Yes | 90 | 96 |
| Ex. 5 | 198 | Negative electrode | 20 | Yes | 90 | 95 |
| Ex. 6 | 791 | Negative electrode | 20 | Yes | 99 | 86 |
| Ex. 7 | 395 | Negative electrode | 10 | Yes | 98 | 88 |
| Ex. 8 | 395 | Positive electrode | *P.E.: 10 | Yes | 97 | 91 |
| | | Negative electrode | N.E.: 10 | | | |
| Ex. 9 | 395 | Negative electrode | 10 | Yes | 98 | 88 |
| Ex. 10 | 395 | Negative electrode | 10 | Yes | 98 | 87 |
| Comp. | 395 | Negative electrode | 0 | Yes | 98 | 45 |
| Ex. 1 | | | | | | |
| Comp. | 395 | Negative electrode | 7 | Yes | 97 | 65 |
| Ex. 2 | | | | | | |
| Comp. | 395 | Negative electrode | 80 | Yes | 75 | 96 |
| Ex. 3 | | | | | | |
| Comp. | 395 | Negative electrode | 30 | No | 62 | 90 |
| Ex. 4 | | | | | | |
| Comp. | 106 | Negative electrode | 20 | Yes | 20 | 93 |
| Ex. 5 | | | | | | |

*“P.E.” and “N.E.” represent positive electrode and negative electrode, respectively.

The battery of COMPARATIVE EXAMPLE 1 in which the porous heat-resistant layer 3 was not formed exhibited favorable initial output characteristic, but after the repetition of the high power discharge cycle, its capacity degraded significantly. In contrast, the batteries of EXAMPLEs 1 to 4, 7 and 8 in which the porous heat-resistant layer 3 having a thickness of 10 to 60 μm was formed on the negative electrode alone or on both the positive and negative electrodes exhibited excellent capacity retention rate in the high power discharge cycle without impairing the initial output characteristic. Particularly, the batteries of EXAMPLEs 2 and 3 in which the porous heat-resistant layer 3 had a thickness of 20 to 40 μm has proven to have an excellent balance of initial output characteristic and high power discharge cycle characteristic.

The battery of COMPARATIVE EXAMPLE 2 in which the porous heat-resistant layer 3 had a thickness of 7 μm exhibited a great degradation in cycle life characteristic, although not as great as for the battery of COMPARATIVE EXAMPLE 1. The battery of COMPARATIVE EXAMPLE 3 in which the porous heat-resistant layer 3 had a thickness of 80 μm exhibited favorable cycle life characteristic, but its initial output characteristic was low. This is because the porous heat-resistant layer 3 had poor electrolyte retention capability than the microporous separator 2, as described previously. This tendency is particularly clear in the comparison between the battery of EXAMPLE 1 having the 20 μm thick separator 2 and the 10 μm thick porous heat-resistant layer 3 and that of COMPARATIVE EXAMPLE 4 having the 30 μm thick porous heat-resistant layer 3.

The effect of the porous heat-resistant layer 3 becomes pronounced in a high power lithium ion secondary battery in which the area per theoretical capacity of the positive electrode is 190 to 800 cm²/Ah. It also indicates that when the porous heat-resistant layer 3 having such thickness is formed in a battery having a small positive electrode surface, as in the battery of COMPARATIVE EXAMPLE 5, a decrease in reactivity caused by the reduction of the electrode area is accelerated, and therefore the initial output characteristic degrades.

Further, in the assembled batteries of COMPARATIVE EXAMPLEs 9 and 10 in which a plurality of batteries of EXAMPLE 1 were connected in series and/or in parallel, the capacity retention rate in the high power discharge cycle was successfully improved without impairing the initial output characteristic.

According to the present invention, it is possible to provide a non-aqueous electrolyte secondary battery having excellent high power characteristic and less degradation In capacity even when high power discharge is repeated. The secondary battery of the present invention is applicable as a power source for driving devices that require high power including hybrid electric vehicles (HEVs) and power tools. Accordingly, the present invention has great applicability and is highly useful.

1. A non-aqueous electrolyte secondary battery comprising a positive electrode, a negative electrode, a microporous resin separator and a non-aqueous electrolyte,
wherein an area per theoretical capacity of said positive electrode is 190 to 800 cm²/Ah, and
a porous heat-resistant layer having a thickness of 10 to 60 μm is formed between said separator and at least one of said positive electrode and said negative electrode.

2. The non-aqueous electrolyte secondary battery in accordance with claim 1,
wherein said porous heat-resistant layer is formed on a surface of at least one of said positive electrode and said negative electrode.

3. The non-aqueous electrolyte secondary battery in accordance with claim 1,
wherein said porous heat-resistant layer comprises an insulating filler.

4. The non-aqueous electrolyte secondary battery in accordance with claim 3,
wherein said insulating filler comprises an inorganic oxide.

5. A power source device comprising a plurality of the non-aqueous electrolyte secondary batteries in accordance with claim 1 connected in series or in parallel.
